(19) United States
(12) Patent Application Publication
(10) Pub. No.: US 2025/0317791 A1
(43) Pub. Date: Oct. 9, 2025

(54) Low Latency Triggered Transmission Opportunity (TXOP) Sharing

(71) Applicant: Ofinno, LLC, Reston, VA (US)

(72) Inventors: Serhat Erkucuk, Reston, VA (US); Jeongki Kim, Fairfax, VA (US); Esmael Hejazi Dinan, McLean, VA (US); Leonardo Alisasis Lanante, Reston, VA (US)

(73) Assignee: Ofinno, LLC, Reston, VA (US)

(21) Appl. No.: 19/240,263

(22) Filed: Jun. 17, 2025

Related U.S. Application Data
(63) Continuation of application No. PCT/US2023/084705, filed on Dec. 19, 2023.
(60) Provisional application No. 63/434,960, filed on Dec. 23, 2022.

(51) Int. Cl. H04W 28/02; H04W 72/0446

(52) U.S. Cl. CPC H04W 28/0268; H04W 72/0446

(57) ABSTRACT

A first station (STA) transmits to an access point (AP) a first frame comprising a request for urgent transmission for a stream from the first STA to a second STA. The first STA receives from the AP a multi-user request-to-send (MU-RTS) Triggered Transmission Opportunity (TXOP) Sharing (TXS) trigger (MRTT) frame indicating: an allocated time of a TXOP obtained by the AP; and a STA allocation for the TXOP, wherein the STA allocation comprises the first STA in response to the AP accepting the request for urgent transmission from the first STA.

### CROSS-REFERENCE TO RELATED APPLICATIONS

This application is a continuation of International Application No. PCT/US2023/084705, filed Dec. 19, 2023, which claims the benefit of U.S. Provisional Application No. 63/434,960, filed Dec. 23, 2022, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example of a Quality of Service (QOS) null frame indicating buffer status information.

FIG. 5 illustrates an example format of a physical layer (PHY) protocol data unit (PPDU).

FIG. 6 is an example diagram of a Multi-User Request-to-Send (MU-RTS) trigger frame which may be used in a triggered Transmission Opportunity (TXOP) sharing (TXS) procedure.

FIG. 7 illustrates an example of a triggered TXS procedure (Mode=1).

FIG. 8 illustrates an example of a triggered TXS procedure (Mode=2).

FIG. 9 is an example that illustrates an SCS request and response procedure that may be used by a STA to initiate stream classification of a stream at the AP.

FIG. 10 illustrates an example QoS Characteristics element.

FIG. 11 is an example that illustrates existing procedure for updating traffic information for the purpose of performing an urgent transmission by a STA.

FIG. 12 illustrates an example of a proposed procedure for urgent transmission according to an embodiment.

FIG. 13 illustrates another example of the proposed procedure for urgent transmission according to an embodiment.

FIGS. 14A-14D illustrate examples of frames/fields which may be used in embodiments of the present disclosure.

FIG. 15 illustrates an example process according to an embodiment.

FIG. 16 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described example embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

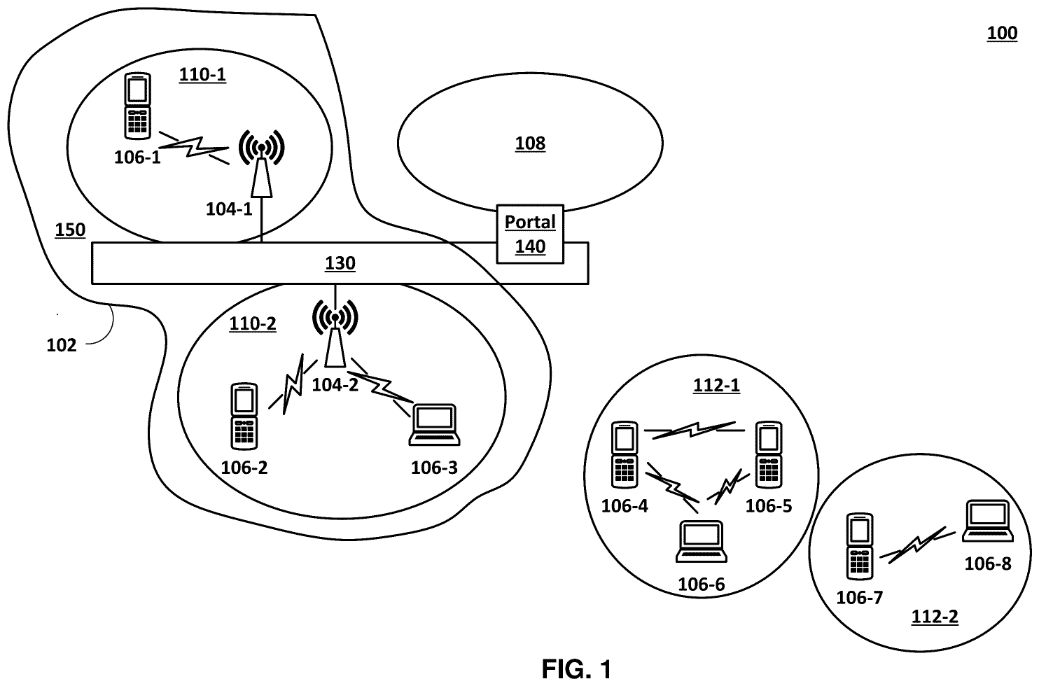

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHZ, 5 GHZ, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHZ, 80 MHZ, 160 MHZ, or 520 MHz by bonding together multiple 20 MHz channels.

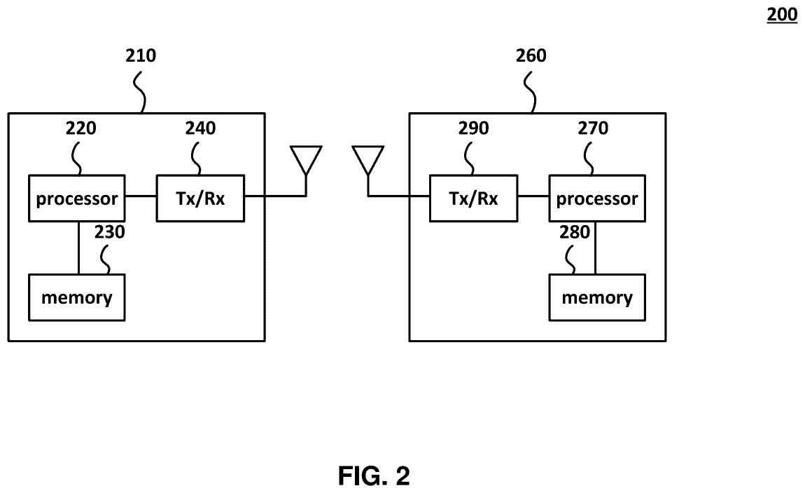

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

When the embodiments are executed by software, the techniques (or methods) described herein can be executed with modules (e.g., processes, functions, and so on) that perform the functions described herein. The modules can be stored in memory 230/280 and executed by processor 220/270. Memory 230/280 may be implemented (or positioned) within processor 220/270 or external to processor 220/270. Memory 230/280 may be operatively connected to processor 220/270 via various means known in the art.

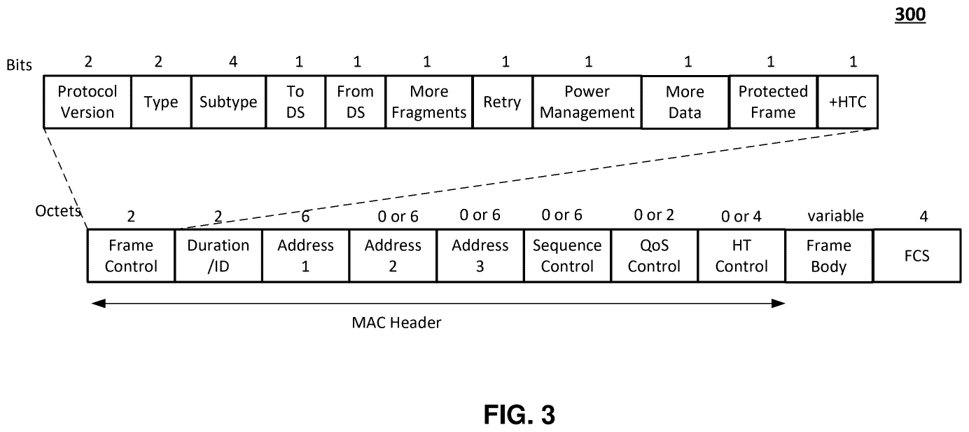

FIG. 3 illustrates an example 300 of a MAC frame format. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control fields include the following subfields: protocol version, type, subtype, To DS, From DS, more fragments, retry, power management, more data, protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS subtype data frame, which is a data frame that contains a QoS control field in its MAC header. The second MSB of the subtype field, bit 6 (B6) of the frame control field, when set to 1 in data subtypes, indicates a data frame that contain no frame body field.

The To DS subfield indicates whether a data frame is destined to the distribution system (DS). The From DS subfield indicates whether a data frame originates from the DS.

The more fragments subfield is set to 1 in all data or management frames that have another fragment to follow of the MAC service data unit (MSDU) or MAC management protocol data unit (MMPDU) carried by the MAC frame. It is set to 0 in all other frames in which the more fragments subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The More Data subfield indicates to a STA in power save (PS) mode that bufferable units (Bus) are buffered for that STA at the AP. The more data subfield is valid in individually addressed data or management frames transmitted by an AP to a STA in PS mode. The more data subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), and the 2 most significant bits (MSB) are both set to 1. In other frames sent by STAs, the duration/ID field contains a duration value (in microseconds) which is used by a recipient to update a network allocation vector (NAV). The NAV is a counter that it indicates to a STA an amount of time during which it must defer from accessing the shared medium.

There can be up to four address fields in the MAC frame format. These fields are used to indicate the basic service set identifier (BSSID), source address (SA), destination address (DA), transmitting address (TA), and receiving address (RA). Certain frames might not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. It may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

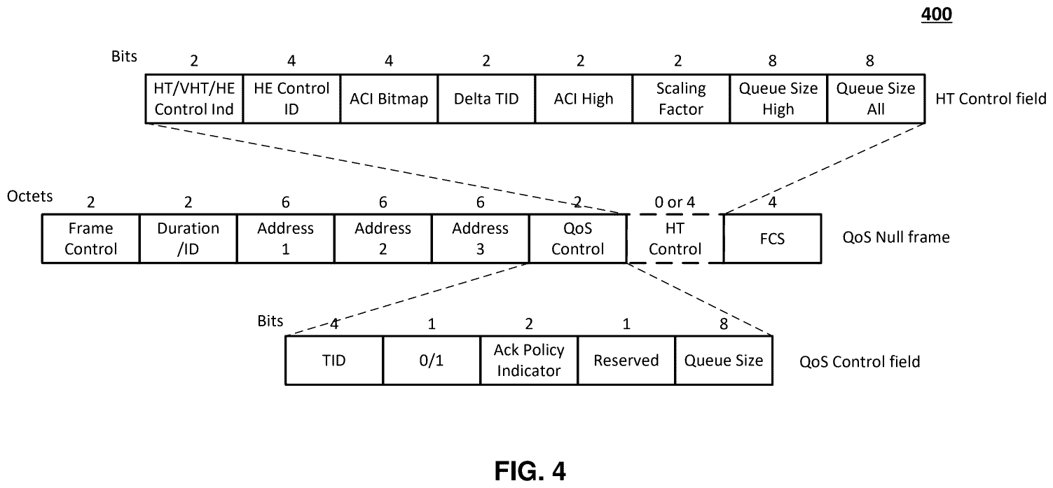

FIG. 4 illustrates an example 400 of a QoS null frame indicating buffer status information. A QoS null frame refers to a QoS data frame with an empty frame body. A QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an ack policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the acknowledgment policy followed upon delivery of the MPDU (e.g., normal ack, implicit block ack request, no ack, block ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine t TXOP duration assigned to the STA or to determine the uplink (UL) resources assigned to the STA.

In a frame sent by or to a non-High Efficiency (non-HE) STA, the following rules may apply to the queue size value:
The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.
A queue size value of 0 is used solely to indicate the absence of any buffered traffic in the queue used for the specified TID.
A queue size value of 254 is used for all sizes greater than 64 768 octets.
A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, on.

A STA obtains the queue size, QS, from a received QoS control field, which contains a scaling factor, SF, and an unscaled value, UV, as follows:

$$QS = 16 \times UV , if SF is equal to 0 ;$$

$$1024 + 256 \times UV , if SF is equal to 1 ;$$

$$17 \; 408 + 2048 \times UV , if SF is equal to 2 ;$$

$$148 \; 480 + 32 \; 768 \times UV , if SF is equal to 3 and UV is less than 62 ;$$

$$> 2 \; 147 \; 328 , if SF equal to is 3 and UV is equal to 62 ;$$

Unspecified or Unknown, if SF is equal to 3 and UV is equal to 63.

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 us to 8160 us in increments of 32 us.

The HT control field may include a BSR control subfield which may contain buffer status information used for UL MU operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all Acs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

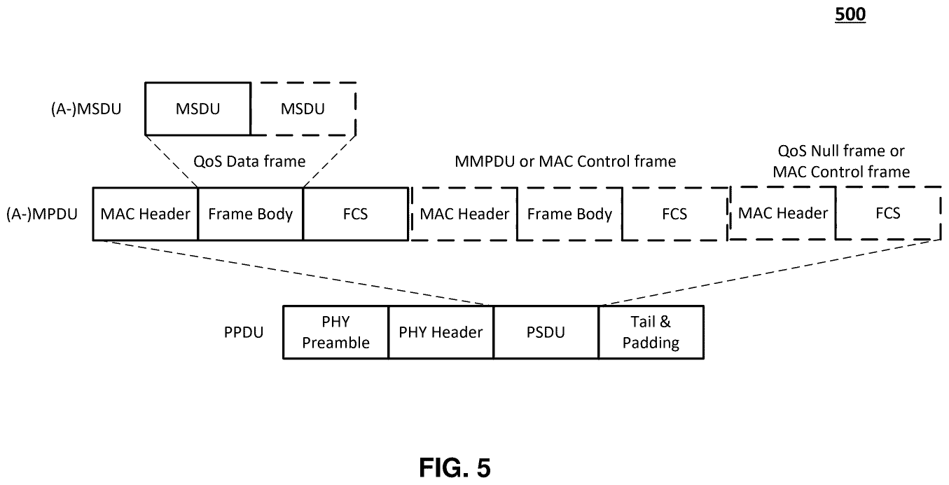

FIG. 5 illustrates an example format of a PPDU. As shown, the PPDU may include a PHY preamble, a PHY header, a PSDU, and tail and padding bits.

The PSDU may include one or more MPDUs, such as a QoS data frame, an MMPDU, a MAC control frame, or a QoS null frame. In the case of an MPDU carrying a QoS data frame, the frame body of the MPDU may include a MSDU or an A-MSDU.

By default, MSDU transport is on a best-effort basis. That is, there is no guarantee that a transmitted MSDU will be delivered successfully. However, the QoS facility uses a traffic identifier (TID) to specify differentiated services on a per-MSDU basis.

A STA may differentiate MSDU delivery according to designated traffic category (TC) or traffic stream (TS) of individual MSDUs. The MAC sublayer entities determine a user priority (UP) for an MSDU based on a TID value provided with the MSDU. The QoS facility supports eight UP values. The UP values range from 0 to 7 and form an ordered sequence of priorities, with 1 being the lowest value, 7 the highest value, and 0 falling between 2 and 3.

An MSDU with a particular UP is said to belong to a traffic category with that UP. The UP may be provided with each MSDU at the medium access control service access point (MAC SAP) directly in a UP parameter. An aggregate MPDU (A-MPDU) may include MPDUs with different TID values.

A STA may deliver buffer status reports (BSRs) to assist an AP in allocating UL MU resources. The STA may either implicitly deliver BSRs in the QoS control field or BSR control subfield of any frame transmitted to the AP (unsolicited BSR) or explicitly deliver BSRs in a frame sent to the AP in response to a BSRP Trigger frame (solicited BSR).

The buffer status reported in the QoS control field includes a queue size value for a given TID. The buffer status reported in the BSR control field includes an ACI bitmap, delta TID, a high priority AC, and two queue sizes.

A STA may report buffer status to the AP, in the QoS control field, of transmitted QoS null frames and QoS data frames and, in the BSR control subfield (if present), of transmitted QoS null frames, QoS data frames, and management frames as defined below.

The STA may report the queue size for a given TID in the queue size subfield of the QoS control field of transmitted QoS data frames or QoS null frames; the STA may set the queue size subfield to 255 to indicate an unknown/unspecified queue size for that TID. The STA may aggregate multiple QoS data frames or QoS null frames in an A-MPDU to report the queue size for different TIDs.

The STA may report buffer status in the BSR control subfield of transmitted frames if the AP has indicated its support for receiving the BSR control subfield.

A High-Efficiency (HE) STA may report the queue size for a preferred AC, indicated by the ACI high subfield, in the queue size high subfield of the BSR control subfield. The STA may set the queue size high subfield to 255 to indicate an unknown/unspecified queue size for that AC.

A HE STA may report the queue size for ACs indicated by the ACI bitmap subfield in the queue size all subfield of the BSR control subfield. The STA may set the queue size all subfield to 255 to indicate an unknown/unspecified BSR for those ACs.

In the next Wi-Fi standard, a triggered TXOP sharing (TXS) procedure may allow an AP to allocate a portion of the time within an obtained TXOP to a STA for transmitting one or more non-trigger-based (non-TB) PPDUs. For the triggered TXOP sharing procedure, the AP may transmit a multi-user request-to-send (MU-RTS) trigger frame with a triggered TXOP sharing mode subfield set to a non-zero value. The MU-RTS trigger frame is a trigger frame for triggering CTS frame(s) from multiple users.

In an example embodiment, an MU-RTS TXS (triggered TXOP sharing) trigger (MRTT) frame is a MU-RTS trigger frame with a triggered TXOP sharing mode subfield set to a non-zero value (e.g., 1 or 2).

In an example, during the portion of the allocated time, the STA may transmit the one or more non-TB PPDUs to the AP. In this case, a triggered TXOP sharing mode subfield in an MU-RTS TXS trigger frame may be set to 1.

In an example, during the portion of the allocated time, the STA may transmit the one or more non-TB PPDUs to the AP or a peer STA. In an example, the peer STA may be a STA with a connection for peer-to-peer (P2P) communication or direct communication with the STA. In this case, a triggered TXOP sharing mode subfield in an MU-RTS TXS trigger frame may be set to 2. In an example, the direct wireless link is established according to the tunneled direct link setup (TDLS) protocol.

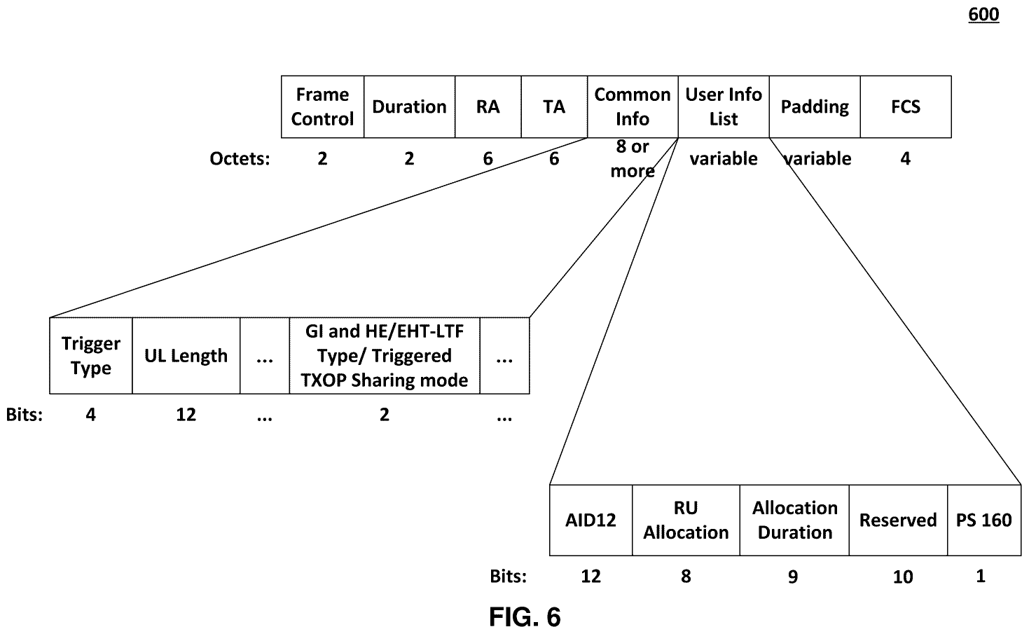

FIG. 6 is an example diagram of an MU-RTS trigger frame which may be used in a TXS procedure.

In an example, the MU-RTS trigger frame may comprise a frame control field, a duration field, a receiver address (RA) field, a transmitter address (TA) field, a common info field, a user info list field, a padding field, and/or frame check sequence (FCS) field.

In an example, the common info field may be a high-efficiency (HE) variant common info field or an extremely high throughput (EHT) variant common info field.

In an example, an EHT variant common info field may comprise one or more of the following subfields: trigger type, UL length, more TF, CS required, UL BW, GI and HE/EHT-LTF Type/Triggered TXOP sharing mode, number of HE/EHT-LTF symbols, LDPC extra symbol segment, AP Tx Power, Pre-FEC padding factor, PE disambiguity, UL spatial reuse, HE/EHT P160, special user info field flag, EHT reserved, reserved, or trigger dependent common info.

In an example, the trigger type subfield may indicate an MU-RTS trigger frame.

In an example, the GI and HE/EHT-LTF Type/Triggered TXOP sharing mode subfield may include a triggered TXOP sharing mode subfield (e.g., when the trigger type subfield indicates an MU-RTS trigger frame).

In an example, the triggered TXOP sharing mode subfield may be set to a non-zero value (e.g., 1 or 2).

In an example, the triggered TXOP sharing mode subfield may indicate that a STA indicated by an AID12 subfield (of the user info list field) of the MU-RTS trigger frame may transmit one or more non-TB PPDUs to the AP during the time indicated by the allocation duration subfield. In this case, the triggered TXOP sharing mode subfield may be set to 1.

In an example, the triggered TXOP sharing mode subfield may indicate that a STA indicated by an AID12 subfield of the MU-RTS trigger frame may transmit one or more non-TB PPDUs to the AP or to a peer STA during the time indicated by the allocation duration subfield. In an example, the peer STA may be a STA with a connection for P2P communication or direct communication with the STA. In this case, the triggered TXOP sharing mode subfield may be set to 2.

In an example, an EHT variant user info field may comprise one or more of the following subfields: AID12, RU allocation, allocation duration, reserved, or PS160.

In an example, the AID12 subfield of the MU-RTS trigger frame may indicate an association identifier (AID) of a STA that may use a time indicated by an allocation duration subfield of the MU-RTS trigger frame.

In an example, the RU allocation subfield of the MU-RTS trigger frame may indicate the location and size of the RU allocated for a STA indicated by an AID12 subfield, which is used together with the PS160 subfield.

In an example, the allocation duration subfield may include an allocation duration subfield (e.g., when the triggered TXOP sharing mode subfield is set to a non-zero value). The allocation duration subfield may indicate a time allocated by an AP transmitting the MU-RTS trigger frame. The allocated time may be a portion of the time of an obtained TXOP by the AP. In an example embodiment, the allocation duration subfield may indicate a first time period.

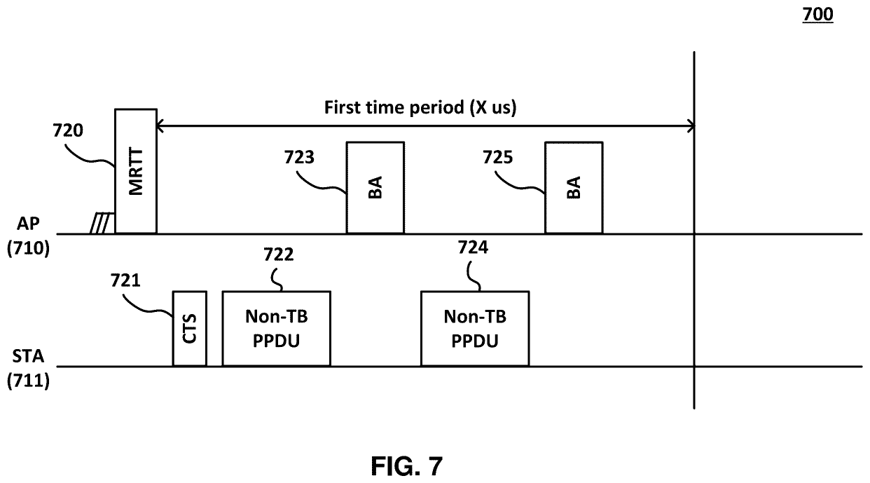

FIG. 7 illustrates an example 700 of a TXS procedure (Mode=1). As shown in FIG. 7, the procedure may begin by an AP 710 transmitting an MU-RTS TXS trigger (MRTT) frame 720 to a STA 711. MRTT frame 720 may allocate a portion of an obtained TXOP to STA 711 and may indicate a triggered TXOP sharing mode equal to 1. STA 711 receiving MRTT frame 720 may use the allocated time duration to transmit one or more non-TB PPDUs 722, 724 to AP 710.

In an example, MRTT frame 720 may comprise a triggered TXOP sharing mode subfield and/or a first time period.

In an example, the first time period may indicate a portion of a time allocated by AP 710 within an obtained TXOP. In an example, the first time period may be indicated by a subfield in MRTT frame 720. In an example, the first time period may be set to a value of X microseconds (us).

In an example, the triggered TXOP sharing mode subfield may be set to 1. The triggered TXOP sharing mode subfield set to 1 may indicate that STA 711 may transmit one or more non-TB PPDUs to AP 710 during the first time period. The one or more non-TB PPDUs may comprise a data frame, a control frame, a management frame, or an action frame.

For example, as shown in FIG. 7, MRTT frame 720 may define a first time period of X us. STA 711 may transmit non-TB PPDUs 722, 724 comprising one or more data frame to AP 710 during the first time period, preceded by a CTS frame 721. In an example, AP 710 may transmit one or more Block Ack (BA) frames 723, 725 in response to the one or more data frames contained in non-TB PPDUs 722, 724 received from STA 711.

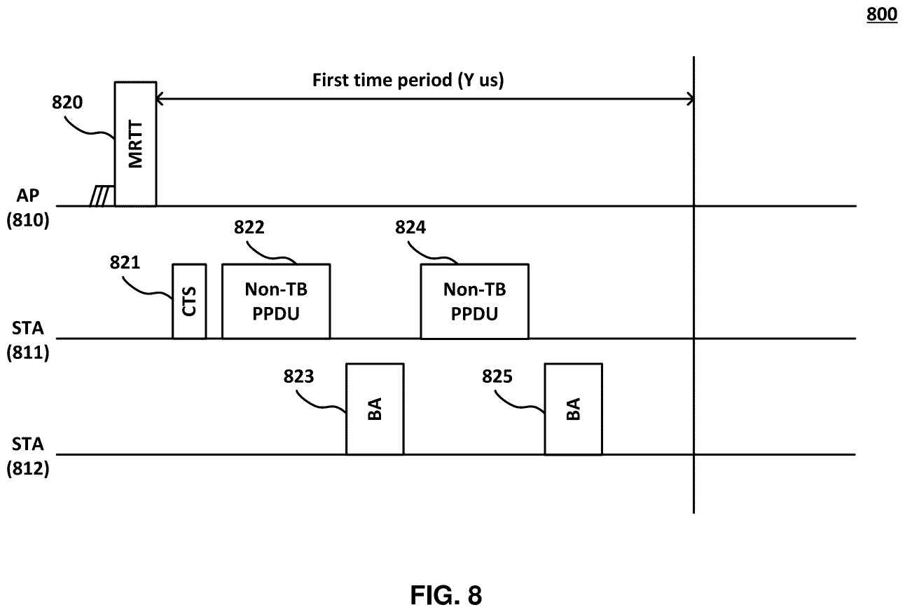

FIG. 8 illustrates an example 800 of a TXS procedure (Mode=2). As shown in FIG. 8, the procedure may begin by an AP 810 transmitting an MRTT frame 820 to a STA 811. MRTT frame 820 may allocate a portion of an obtained TXOP to STA 811 and may indicate a triggered TXOP sharing mode equal to 2. STA 811 receiving MRTT frame 820 may use the allocated time duration to transmit one or more non-TB PPDUs 822, 824 to STA 812.

In an example, MRTT frame 820 may comprise a triggered TXOP sharing mode subfield and/or a first time period.

In an example, the first time period may indicate a portion of a time allocated by AP 810 within an obtained TXOP. In an example, the first time period may be indicated by a subfield in MRTT frame 820. In an example, the first time period may be set to a value of Y us.

In an example, the triggered TXOP sharing mode subfield may be set to 2. The triggered TXOP sharing mode subfield set to 2 may indicate that STA 811 may transmit one or more non-TB PPDUs to AP 810 or to a peer STA during the first time period. In an example, the peer STA may be a STA with a connection for P2P communication or direct communication with STA 811. The one or more non-TB PPDUs may comprise a data frame, a control frame, a management frame, or an action frame.

For example, as shown in FIG. 8, MRTT frame 820 may define a first time period of Y us. STA 811 may transmit non-TB PPDUs 822, 824 comprising one or more data frame to STA 812 during the first time period, preceded by a CTS frame 821. In an example, STA 812 may transmit one or more Block Ack (BA) frames 823, 825 in response to the one or more data frames contained in non-TB PPDUs 822, 824 received from the STA 811.

Generally, before the TXS procedure can be initiated by the AP, the AP should have information regarding traffic to/from STAs for scheduling of uplink, downlink and direct link traffic. The stream classification service (SCS) is a service that may be provided by an AP to its associated STAs that support SCS. In SCS, the AP classifies incoming individually addressed MSDUs from a STA based upon parameters provided by the STA. The classification allows the user priority, drop eligibility, and EDCA transmit queue to be selected for all MSDUs matching the classification.

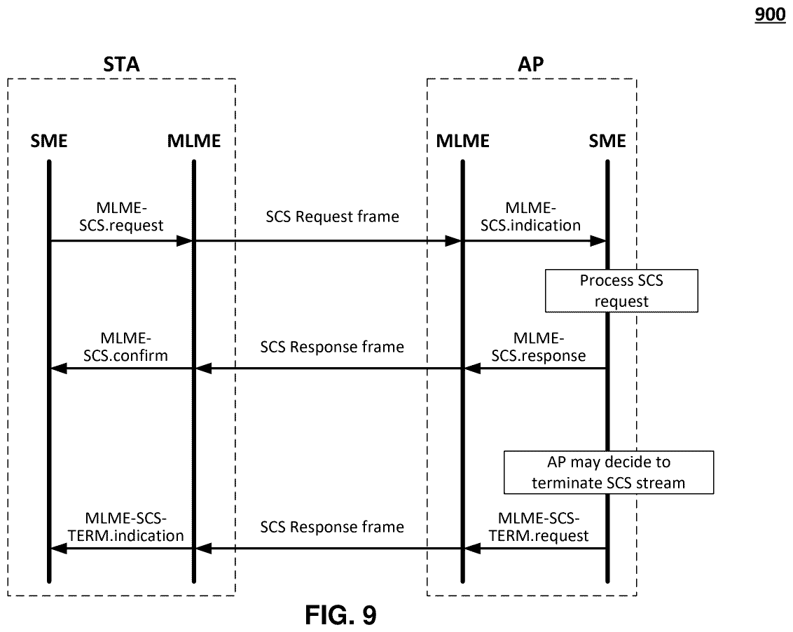

FIG. 9 is an example 900 that illustrates an SCS request and response procedure (as defined in the current IEEE 802.11 standard) that may be used by a STA to initiate stream classification of a stream at the AP. As shown in FIG. 9, the procedure starts with a STA that supports SCS sending an SCS Request frame to an AP (with which the STA is associated). The SCS Request frame may include an SCS Descriptor element with a Request Type field set to “Add” or “Change”. To send the SCS Request frame, a Station Management Entity (SME) of the STA generates an MLME-SCS.request primitive that may comprise PeerSTAAddress, DialogToken, SCSRequest, VendorSpecificInfo parameters and sends the MLME-SCS.request primitive to a MAC Layer Management Entity (MLME) of the STA.

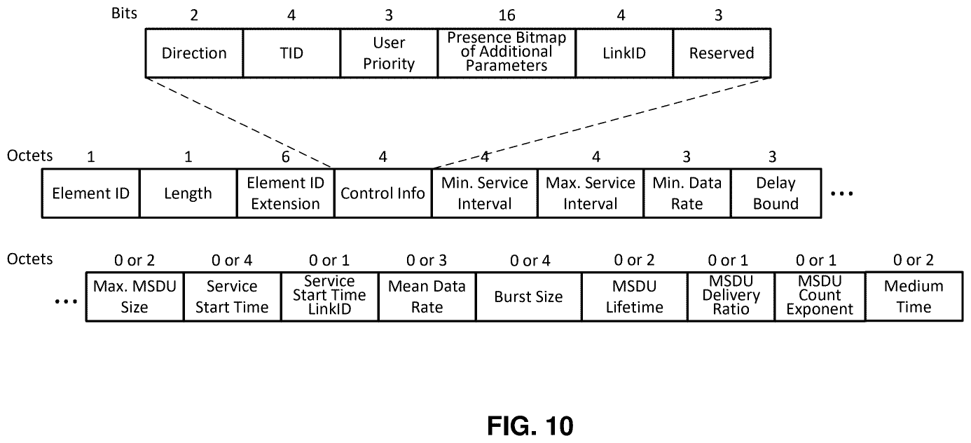

In the MLME-SCS.request primitive, the PeerSTAAddress parameter specifies the address of the peer MAC entity with which the STA wishes to perform the SCS procedure. The DialogToken parameter comprises a dialog token that identifies the SCS request and response transaction. The SCSRequest parameter comprises the SCS Descriptor element, which specifies frame classifiers and a priority for the SCS stream. For IEEE 802.11be systems, the SCS Descriptor element further comprises a QoS Characteristics element that comprises parameters defining the characteristics and/or QoS expectations of the stream. The QoS Characteristics element is further described below with reference to FIG. 10. The VendorSpecificInfo parameter comprises vendor specific elements not defined in the IEEE 802.11 standard.

On receipt of the MLME-SCS.request primitive, the MLME of the STA constructs the SCS Request frame based on the MLME-SCS.request primitive.

The SCS Request frame is received by an MLME of the AP, which generates an MLME-SCS.indication primitive and sends the MLME-SCS.indication primitive to an SME of the AP. The MLME-SCS.indication primitive comprises PeerSTAAddress, DialogToken, SCSRequest, VendorSpecificInfo parameters, which are the same as the corresponding parameters of the MLME-SCS.request primitive.

The AP responds to the SCS Request frame from the STA with an SCS Response frame. Specifically, the SME of the AP generates an MLME-SCS.response primitive based on the MLME-SCS.indication received from the MLME. The MLME-SCS.response primitive comprises PeerSTAAddress, DialogToken, stream classification service identifier (SCSID), Status, VendorSpecificInfo parameters. The PeerSTAAddress parameter indicates the address of the STA MAC entity from which the SCS Request frame was received. The DialogToken and VendorSpecificInfo parameters are the same as explained above for the MLME-SCS.request primitive. The SCSID parameter identifies the SCS stream that is being classified. The Status parameter indicates the result response of the requested SCSID. The Status field value may indicate SUCCESS if the SCS Request frame is accepted. The Status field value may indicate REQUEST_DECLINED, REQUESTED_TCLAS_NOT_SUPPORTED_BY_AP, REJECTED_WITH_SUGGESTED_CHANGES, or INSUFFICIENT_TCLAS_PROCESSING_RESOURCES if the SCS Request frame is not accepted.

If an SCS Request frame with an SCS Descriptor element comprising a QoS Characteristics element is rejected by an AP by setting the Status field value to REJECTED_WITH_SUGGESTED_CHANGES, the AP shall include an SCS Descriptor element containing a QoS Characteristics element in the SCS Response frame signaling the suggested QoS Characteristics parameters for the SCS stream.

On receipt of the MLME-SCS.response primitive, the MLME of the AP constructs the SCS Response frame. The AP then transmits the SCS Response frame to the STA indicated by the PeerSTAAddress parameter.

The SCS Response frame is received by the MLME of the STA, which generates an MLME-SCS.confirm primitive and sends the MLME-SCS.confirm primitive to the SME of the STA. The MLME-SCS.confirm primitive comprises PeerSTAAddress, DialogToken, SCSID, Status, VendorSpecificInfo parameters, which are the same as the corresponding parameters of the MLME-SCS.response primitive parameters.

The SME of the STA determines whether the SCS request has been accepted, declined, or rejected with suggested changes based on the value of the Status field of the MLME-SCS.confirm primitive. In case the SCS request is rejected with suggested changes, the negotiation between the STA and the AP regarding the SCS may continue.

A STA may request the termination of an accepted SCS stream by sending an SCS Request frame with the Request Type field set to “Remove” and the requested SCSIDs in the SCS Descriptor element. Alternatively, the AP may decide to terminate an SCS stream at any time by generating an MLME-SCS-TERM.request primitive and transmitting it to the STA via an SCS Response frame. When the SCS Response frame is received by the MLME of the STA, an MLME-SCS-TERM.indication primitive is generated and sent to the SME of the STA resulting in termination of the SCS stream.

As explained in example 900, the SCS procedure starts with a STA transmitting an SCS Request frame with an SCS Descriptor element comprising a QoS Characteristics element. The QoS Characteristics element comprises the requested traffic information of the STA. The AP considers this information to accept or reject the SCS request.

FIG. 10 illustrates an example QoS Characteristics element. As described above, the QoS Characteristics element may comprise a set of parameters that define the characteristics and/or QoS expectations of a traffic flow

As shown in FIG. 10, the QoS Characteristics element may comprise an Element ID field, a Length field, an Element ID Extension field, a Control Info field, a Minimum Service Interval field, a Maximum Service Interval field, a Minimum Data Rate field, and a Delay Bound field. Optionally, the QoS Characteristics element may further comprise a Maximum MSDU Size field, a Service Start Time field, a Service Start Time LinkID field, a Mean Data Rate field, a Burst Size field, an MSDU Lifetime field, an MSDU Delivery Ratio field, an MSDU Count Exponent field, and/or a Medium Time field.

The Element ID field identifies a group of elements including the QoS Characteristics element. The group of elements may include, in addition to the QoS Characteristics element, an EHT Operation element, a Multi-Link element, an EHT Capabilities element, a TID-To-Link Mapping element, a Multi-Link Traffic Indication element, a MLO Link Information element, and an AID Bitmap element.

The Extended Element ID field may indicate a specific value for distinguishing the QoS Characteristics element from other elements having the same Element ID.

As shown in FIG. 10, the Control Info field may comprise the following subfields: Direction, TID, User Priority, Presence Bitmap of Additional Parameters, LinkID, and Reserved.

The Direction subfield specifies the direction of the data frames described by the QoS Characteristics element as uplink, downlink or direct link.

The TID subfield comprises a TID value of the data frames that are described by the QoS Characteristics element. The TID subfield may be set to the same value as the User Priority field.

The User Priority subfield comprises a user priority value (0-7) of the data frames that are described by the QoS Characteristics element. When the traffic classification (TCLAS) element is present in the SCS Request frame containing the QoS Characteristics element, the User Priority subfield is set to the user priority value specified in the TCLAS element.

The Presence Bitmap of Additional Parameters subfield comprises a bitmap where the i-th entry of the bitmap is set to 1 if the i-th field starting from the Maximum MSDU Size field is present in the QoS Characteristics element. For each field starting from the Maximum MSDU Size field, the value 0 is reserved.

The LinkID subfield comprises a link identifier of a direct (e.g., P2P) link on which frame transmissions will occur. If the Direction subfield is equal a value other than 2 (which corresponds to Direct link), the LinkID subfield is reserved.

The Minimum/Maximum Service Interval fields comprise unsigned integers that specify the minimum/maximum intervals, in microseconds, between the start of two consecutive SPs that are allocated to the STA for direct link frame exchanges. The fields take the reserved value 0, if the Direction subfield is set to 2 (Direct link).

The Minimum Data Rate field comprises an unsigned integer that specifies the lowest data rate specified at the MAC SAP, in kilobits per second, for transport of MSDUs or A-MSDUs belonging to the traffic flow described by this element.

The Delay Bound field comprises an unsigned integer that specifies the maximum amount of time, in micro-seconds, allowed to transport an MSDU or A-MSDU belonging to the traffic flow described by the QoS Characteristics element, measured between the time marking the arrival of the MSDU, or the first MSDU of the MSDUs constituting an A-MSDU, at the local MAC sublayer from the local MAC SAP and the time of completion of the successful transmission or retransmission of the MSDU or A-MSDU to the destination.

Of the optional fields, the Maximum MSDU Size field comprises an unsigned integer that specifies the maximum size, in octets, of MSDUs or A-MSDUs belonging to the traffic flow described by the QoS Characteristics element.

The Service Start Time field comprises an unsigned integer that specifies the anticipated time, in microseconds, when the traffic starts for the associated TID. The Service Start Time indicates to the AP the time when the STA expects to exchange frames corresponding to the TID specified in the QoS Characteristics element. The field represents the four lower order octets of the timing synchronization function (TSF) timer associated to the link specified in the LinkID field at the start of the anticipated SP.

The Service Start Time LinkID field indicates the link identifier that corresponds to the link for which the TSF timer is used to indicate the Service Start Time.

The Mean Data Rate field indicates the average data rate specified at the MAC SAP, in kilobits per second, for transport of MSDUs or A-MSDUs belonging to the traffic flow within the bounds of this element.

The Burst Size field comprises an unsigned integer that specifies the maximum burst, in octets, of the MSDUs or A-MSDUs belonging to the traffic flow that arrive at the MAC SAP within a time duration specified in the Delay Bound field.

The MSDU Lifetime field comprises an unsigned integer that specifies the maximum amount of time, in milliseconds, from the arrival of the MSDU at the MAC data service interface beyond which the MSDU is not useful even if received by the receiver. Therefore, the MSDU transmitter may consider discarding such MSDU at the transmitter before it is transmitted over-the-air. The amount of time specified in this field is larger than or equal to the amount of time specified in the Delay Bound field, if present.

The MSDU Delivery Ratio field specifies the MSDU loss requirement. The MSDU Count Exponent field comprises an unsigned integer that specifies the exponent from which the number of incoming MSDUs used for computing the MSDU delivery ratio is obtained.

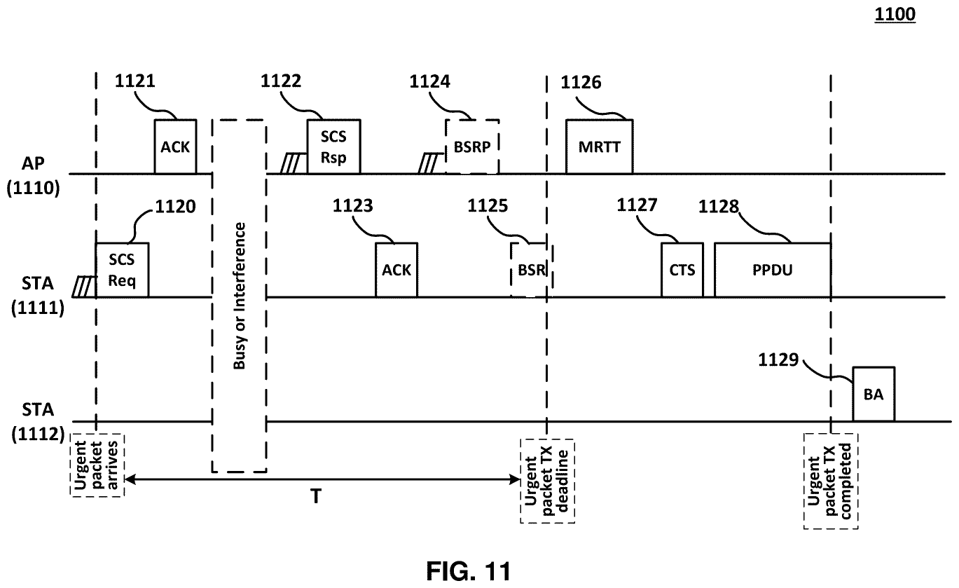

After completion of the SCS procedure, the AP may consider the traffic information obtained from a STA during the SCS procedure for scheduling traffic relating to the STA including P2P traffic between the STA and another STA. For example, the AP may allocate the STA in a TXS procedure based on the traffic information (and BSR information received from the STA). However, there may be cases in which a STA may have urgent data to transmit to another STA due to a sudden change in traffic conditions. This is a very likely scenario in future IEEE 802.11 radios (e.g., Ultra-High Reliability (UHR) 802.11 radios), as low-latency P2P communications are expected in various applications, including but not limited to, augmented reality (AR) and virtual reality (VR) for example. The STA may thus need to update the traffic information and/or the traffic QoS parameters with the AP to be allocated accordingly in an upcoming TXOP. FIG. 11 described below is an example 1100 that illustrates existing operation in such a scenario.

As shown in FIG. 11, example 1100 includes an AP 1110 and a plurality of STAs 1111 and 1112. STAs 1111 and 1112 may be associated with AP 1110.

In example 1100, STA 1111 may have urgent data to transmit to peer STA 1112 within T-units of time of its arrival. In an example, the urgent data may result from a sudden change in application traffic. According to existing operation, STA 1111 initiates an SCS request and response procedure to update the traffic information and/or the traffic QoS parameters with AP 1110. As such, STA 1111 may transmit an SCS Request frame 1120 to AP 1110. The SCS Request frame 1120 may comprise an SCS Descriptor element comprising a QoS Characteristics element of the urgent traffic to be transmitted. In an example, in response to the SCS Request frame 1120, AP 1110 may transmit an ACK frame 1121 to STA 1111. In another example, in response to the SCS Request frame 1120, AP 1110 may not transmit an ACK frame 1121 to STA 1111.

When AP 1110 receives SCS Request frame 1120, AP 1110 processes the SCS Descriptor element comprising the QoS Characteristics element and decides on the traffic QoS parameters. AP 1110 may send an SCS Response frame 1122 to STA 1111 based on the decision. In an example, the Status field value of the SCS Response frame may indicate Success. In another example, the Status field value of the SCS Response frame may indicate Reject. In a further example, the Status field value of the SCS Response frame may indicate reject with suggested changes. If the status field value of SCS Response frame indicates reject with suggested changes, STA 1111 may send another SCS Request frame as part of the negotiation process. After receiving the SCS Response frame 1122, STA 1111 may send an ACK 1123 to AP 1110.

In an example, AP 1110 may be busy performing other ongoing SCS procedures and/or communications with other STAs at the time that it receives SCS Request frame 1120 from STA 1111. As such, AP 1110 may acknowledge SCS Request frame 1120 but may not immediately send an SCS Response frame to STA 1111. In another example, channel interference may result in SCS Request frame 1120 and/or SCS Response frame 1122 to be received in error. In such cases, the performance of the SCS procedure as well as the update of the traffic information and/or traffic QoS parameters may be delayed.

After transmitting SCS Response frame 1122 indicating Success, AP 1110 may transmit a BSR Poll (BSRP) frame 1124 to STA 1111. In another example, buffer status report information from STA 1111 may already be available at AP 1110; hence AP 1110 may not transmit BSRP frame 1124. In response to BSRP frame 1124, STA 1111 may transmit BSR frame 1125. BSR frame 1125 comprises BSR information including a BSR for the direct traffic from STA 1111 to STA 1112.

Next, AP 1110 may transmit an MRTT frame 1126 to allocate a portion of an obtained TXOP to associated STAs. MRTT frame 1126 may be a broadcast frame. MRTT frame 1126 may enable a STA to communicate with the AP or with a respective peer STA during the time allocated by the MRTT frame 1126. In an example, a Target AID for an allocated STA may be provided in a User Info field for the allocated STA in MRTT frame 1126. In example 1100, based on the updated traffic information and/or traffic QoS parameters, AP 1110 may use MRTT frame 1126 to allocate a portion of the obtained TXOP to STA 1111 to allow STA 1111 to transmit its urgent traffic to STA 1112. In an example, a triggered TXOP sharing mode of MRTT frame 1126 may be set to 2 indicating that STA 1111 may transmit either to AP 1110 or to a peer STA, e.g., to STA 1112, during the allocated time.

In response to MRTT frame 1126 having the triggered TXOP sharing mode set to 2, STA 1111 may transmit a CTS frame 1127 to AP 1110, followed by a PPDU 1128 to STA 1112. PPDU 1128 transmitted by STA 1111 may include a data frame of the urgent traffic at STA 1111. STA 1112 may transmit a Block Ack (BA) frame 1129 in response to the data frame contained in PPDU 1128.

As illustrated in FIG. 11, because of the length of the existing SCS procedure, the elapsed time from the transmission of SCS Request frame 1120 from STA 1111 to AP 1110 to the transmission of PPDU 1128 from STA 1111 to STA 1112 may be greater than the T-units time, within which the urgent data at STA 1111 must be transmitted. STA 1111 may thus discard the urgent data without transmitting it to STA 1112. Performance of the application running at STA 1112 may thus be impacted.

Embodiments of the present disclosure, as further described below, address the above-described problem. In one aspect, embodiments enable a STA to transmit a request for urgent transmission to an AP. The request for urgent transmission may indicate a request for allocation of the STA during an upcoming TXOP by the AP (e.g., a request for a TXOP). The request for urgent transmission may relate to a data stream from the STA to another peer STA. In another aspect, the STA may send QoS parameters relating to the stream, alternatively or additionally to the request for urgent transmission, to re-classify the stream. The AP accepting the request for urgent transmission and/or the QoS parameters may send an MRTT frame allocating the STA for an upcoming TXOP. The need to perform the lengthy SCS negotiation process between the AP and the STA described above may thus be obviated, and urgent data at the STA may be transmitted in a shorter time frame.

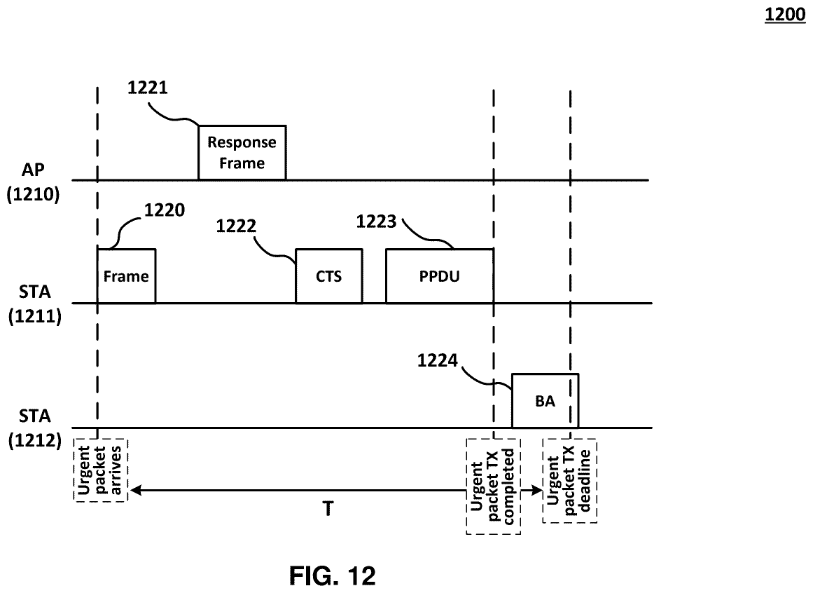

FIG. 12 illustrates an example 1200 of a proposed procedure for urgent transmission according to an embodiment. As shown in FIG. 12, example 1200 includes an AP 1210 and STAs 1211 and 1212. STAs 1211, 1212 may be associated with AP 1210. In an embodiment, AP 1210 and STAs 1211-1212 may comprise respective multi-link devices (MLDs).

It is assumed in example 1200 that STA 1211 is in communication with STA 1212 via a direct link to transmit a data stream to STA 1212. The stream may be associated with an application running at STA 1211 and/or STA 1212. In an example, before starting the transmission of the stream to STA 1212, STA 1211 may perform an SCS request and response procedure as described with reference to FIG. 9 above. Specifically, STA 1211 may transmit an SCS request to AP 1210 comprising a first QoS Characteristics element for the stream. In response, AP 1210 may transmit to STA 1211 an SCS response comprising a second QoS Characteristics element for the stream. The SCS request and response procedure may result in a classification of the stream from STA 1211 to STA 1212. AP 1210 may use the classification of the stream in determining the STA allocation for a TXOP obtained by the AP (The STA allocation indicates the STAs that are allocated during the TXOP using TXS).

As shown in FIG. 12, example 1200 may begin by STA 1211 having urgent data associated with the stream to transmit to STA 1212. In an example, the urgent data may be of one PPDU duration. In an example, the urgent data may be longer than one PPDU duration. In an example, the urgent data may be associated with latency sensitive traffic. In an example, urgent data may be associated with an application having high priority. In an example, the urgent data must be transmitted within T-units of time from its arrival at STA 1212.

In an example, STA 1211 may transmit to AP 1210 a first frame 1220 comprising a request for urgent transmission (e.g., a request for a TXOP) for the stream from STA 1211 to STA 1212. In an example, the request for urgent transmission indicates a request for allocation of STA 1211 during an upcoming (e.g., next) TXOP obtained by AP 1210.

In an example, the request for urgent transmission may have a duration. In an example, the duration may indicate a required/requested channel access time by STA 1211. In another example, the request for urgent transmission may not have a duration.

In an example, frame 1220 is a QoS data/null frame comprising a QoS control field, where the QoS control field comprises the request for urgent transmission. In another example, frame 1220 is a QoS data/null frame comprising a HT control field, where the HT control field comprises the request for urgent transmission. In a further example, frame 1220 is an action frame, and the request for urgent transmission is provided in an action element of the action frame.

In another example, frame 1220 may further comprise QoS parameters associated with the stream. The QoS parameters may be determined by STA 1211 based on changes in traffic conditions/requirements of the stream, which may have resulted in the need for urgent data transmission at STA 1211. In an example, the QoS parameters are provided in a QoS Characteristics element. In an example, frame 1220 requests a classification of the stream based on the QoS parameters. In an example, the requested classification is intended to override an existing classification of the stream for an indicated duration. In another example, the requested classification is intended to change an existing classification of the stream (e.g., when a duration is not indicated). In another embodiment, frame 1220 may comprise QoS parameters associated with the stream without including a request for urgent transmission.

In an example, frame 1220 is a QoS null frame comprising buffer status report (BSR) information. In an example, the QoS null frame further comprises an A-Control field comprising the QoS parameters associated with the stream. In an example, frame 1220 is a data frame. In another example, frame 1220 is a BSR frame.

In an example, frame 1220 is an action frame, where the action frame comprises buffer status report (BSR) information. In an example, the BSR information comprises the QoS parameters associated with the stream.

In an example, frame 1220 comprises an SCS Request frame, where the SCS Request frame comprises an SCS Descriptor element further comprising the QoS parameters associated with the stream.

In an embodiment, in response to frame 1220, AP 1210 may transmit a response frame 1221 to STA 1211. AP 1210 may transmit response frame 1221 based on accepting the request for urgent transmission and/or the QoS parameters indicated in frame 1220. In an embodiment, the response frame 1221 may be an MRTT frame. The MRTT frame may indicate an allocated time of a TXOP obtained by the AP and a STA allocation for the TXOP. In an embodiment, based on the MRTT frame being in response to AP 1210 accepting the request for urgent transmission and/or the QoS parameters indicated in frame 1220, the STA allocation comprises STA 1211. In an example, the MRTT frame may further comprise an allocation duration for STA 1211, the allocation duration configured to allow STA 1211 to transmit the urgent data to STA 1212 within the T-units of time associated with the urgent data.

After receiving response frame 1221, STA 1211 may transmit a CTS frame 1222 to AP 1210, followed by a PPDU 1223 to STA 1212. PPDU 1223 may comprise a data frame of the urgent data. In an example, PPDU 1223 may be transmitted within the T-units of time associated with the urgent data ensuring timely transmittal of the urgent data. STA 1212 may transmit a Block Ack (BA) frame 1224 to STA 1211 in response to the data frame(s) contained in PPDU 1223.

As described above, using the proposed procedure, a request for urgent transmission and/or suggested stream QoS parameters from a STA can be immediately accepted and responded to by a STA by merely allocating the STA during an upcoming TXOP. In contrast, the existing procedure necessitates a lengthy SCS request and response procedure, before time critical data can be transmitted. In an example, the request for urgent transmission may be for a limited duration (e.g., one-time only) with no QoS parameters reported to the AP. In another example, the request for urgent transmission may be accompanied by QoS parameters that override an existing classification of the stream for an indicated duration. In another example, the request for urgent transmission may be accompanied by QoS parameters that change an existing classification of the stream (e.g., when a duration field is not present).

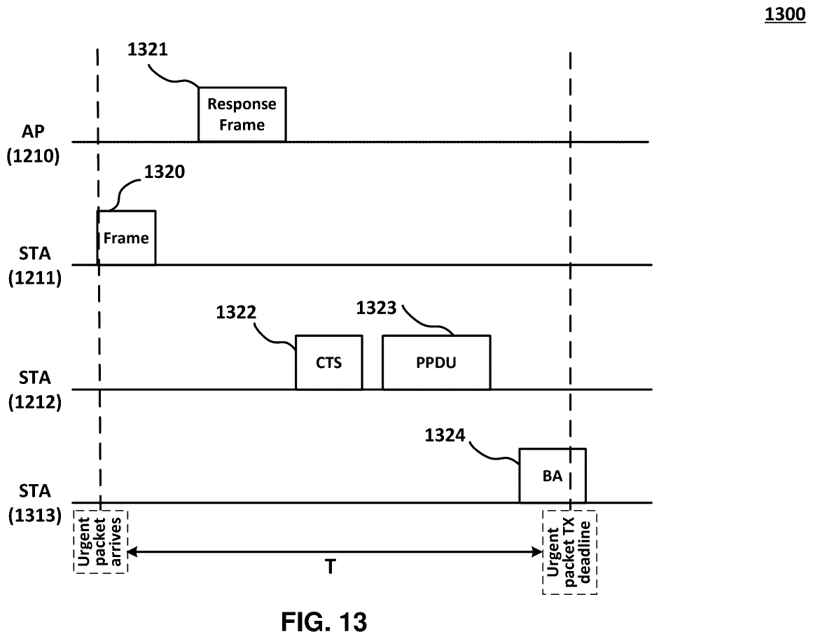

In an embodiment, when the AP does not accept a request for urgent transmission and/or suggested QoS parameters from the STA, the existing classification of the stream is maintained. FIG. 13 below provides an example illustrating such an embodiment.

FIG. 13 illustrates another example 1300 of the proposed procedure for urgent transmission according to an embodiment. As shown in FIG. 13, example 1300 includes an AP 1210 and STAs 1211, 1212, 1313. STAs 1211, 1212 1313 may be associated with AP 1210. In an embodiment, AP 1210 and STAs 1211, 1212, 1313 may comprise respective multi-link devices (MLDs).

It is assumed in example 1300 that STA 1211 is in communication with STA 1212 via a direct link to transmit a data stream to STA 1212. The stream may be associated with an application running at STA 1211 and/or STA 1212. In an example, before starting the transmission of the stream to STA 1212, STA 1211 may perform an SCS request and response procedure as described with reference to FIG. 9 above. Specifically, STA 1211 may transmit an SCS request to AP 1210 comprising a first QoS Characteristics element for the stream. In response, AP 1210 may transmit to STA 1211 an SCS response comprising a second QoS Characteristics element for the stream. The SCS request and response procedure may result in a classification of the stream from STA 1211 to STA 1212. AP 1210 may use the classification of the stream in determining the STA allocation for a TXOP obtained by the AP (The STA allocation indicates the STAs that are allocated during the TXOP using TXS).

As shown in FIG. 13, example 1300 may begin by STA 1211 having urgent data associated with the stream to transmit to STA 1212. In an example, the urgent data may be of one PPDU duration. In an example, the urgent data may be longer than one PPDU duration. In an example, the urgent data may be associated with latency sensitive traffic. In an example, urgent data may be associated with an application having high priority. In an example, the urgent data must be transmitted within T-units of time from its arrival at STA 1212.

In an example, STA 1211 may transmit to AP 1210 a first frame 1320 comprising a request for urgent transmission (e.g., a request for a TXOP) for the stream from STA 1211 to STA 1212. In an example, the request for urgent transmission indicates a request for allocation of STA 1211 during an upcoming (e.g., next) TXOP obtained by AP 1210.

In an example, the request for urgent transmission may have a duration. In an example, the duration may indicate a required/requested channel access time by STA 1211. In another example, the request for urgent transmission may not have a duration.

In an example, frame 1320 is a QoS data/null frame comprising a QoS control field, where the QoS control field comprises the request for urgent transmission. In another example, frame 1320 is a QoS data/null frame comprising a HT control field, where the HT control field comprises the request for urgent transmission. In a further example, frame 1320 is an action frame, and the request for urgent transmission is provided in an action element of the action frame.

In another example, frame 1320 may further comprise QoS parameters associated with the stream. The QoS parameters may be determined by STA 1211 based on changes in traffic conditions/requirements of the stream, which may have resulted in the need for urgent data transmission at STA 1211. In an example, the QoS parameters are provided in a QoS Characteristics element. In an example, frame 1320 requests a classification of the stream based on the QoS parameters. In an example, the requested classification is intended to override an existing classification of the stream for an indicated duration. In another example, the requested classification is intended to change an existing classification of the stream (e.g., when a duration is not indicated). In another embodiment, frame 1320 may comprise QoS parameters associated with the stream without including a request for urgent transmission.

In an example, frame 1320 is a QoS null frame comprising buffer status report (BSR) information. In an example, the QoS null frame further comprises an A-Control field comprising the QoS parameters associated with the stream. In an example, frame 1320 is a data frame. In another example, frame 1320 is a BSR frame.

In an example, frame 1320 is an action frame, where the action frame comprises buffer status report (BSR) information. In an example, the BSR information comprises the QoS parameters associated with the stream.

In an example, frame 1320 comprises an SCS Request frame, where the SCS Request frame comprises an SCS Descriptor element further comprising the QoS parameters associated with the stream.

In example 1300. AP 1210 does not accept the request for urgent transmission and/or the QoS parameters indicated in frame 1320 from STA 1211. In an embodiment, based on not accepting the request for urgent transmission and/or the QoS parameters indicated in frame 1320, AP 1210 may transmit a response frame 1321, not to STA 1211, but to STA 1212 for example. Response frame 1321 may be an MRTT frame. The MRTT frame may indicate an allocated time of a TXOP obtained by the AP and a STA allocation for the TXOP. In an embodiment, based on the MRTT frame being in response to AP 1210 not accepting the request for urgent transmission and/or the QoS parameters indicated in frame 1320, the STA allocation may comprise STA 1212. In an example, the MRTT frame may further comprise an allocation duration for STA 1212.

After receiving response frame 1321, STA 1212 may transmit a CTS frame 1322 to AP 1210, followed by a PPDU 1323 to STA 1313. STA 1313 may transmit a Block Ack (BA) frame 1324 to STA 1212 in response to the data frame(s) contained in PPDU 1323. As illustrated in example 1300, based on the AP 1210 not accepting the request for urgent transmission and/or the QoS parameters indicated in frame 1320, the urgent data of STA 1211 may not be transmitted to STA 1212 in a timely manner. STA 1211 may discard the urgent data or resort to other existing mechanisms to transmit the urgent data to STA 1212.

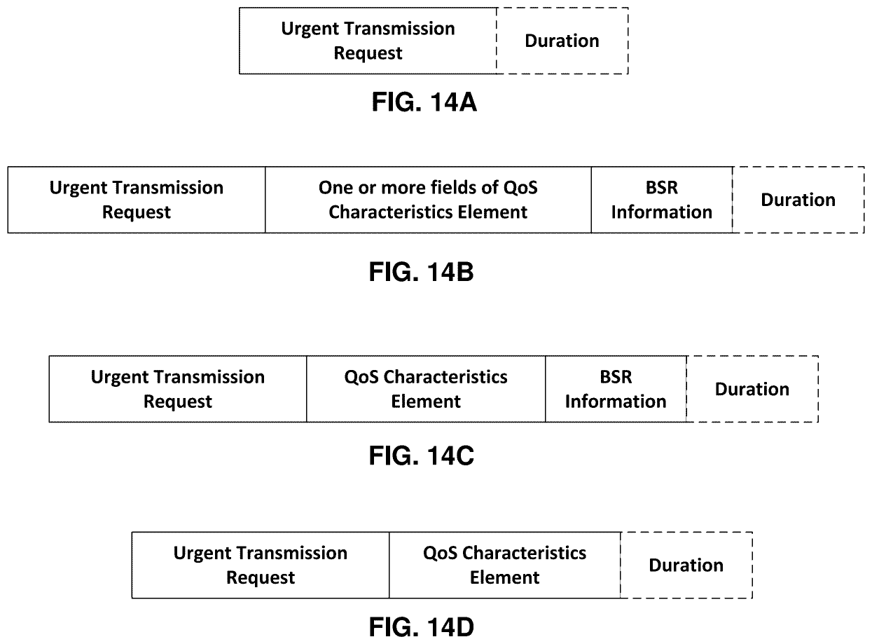

FIGS. 14A-14D illustrate examples of frames/fields which may be used in embodiments of the present disclosure.

In an embodiment, as described above, the frame from the STA (e.g., frame 1220 or 1320) may comprise a request for urgent transmission and optionally a duration of the request as shown in FIG. 14A. In an embodiment, the frame from the STA may be a QoS data/null frame similar to QoS null frame 400 described with reference to FIG. 4 above. The QoS data/null frame may comprise a QoS control field and a Duration/ID field. In such an embodiment, the request for urgent transmission may be included in a reserved bit of the QoS control field. If the frame also comprises a duration, the duration may be included in the Duration/ID field. In another embodiment, the frame from the STA may be a QoS data/null frame comprising an HT control field. In such an embodiment, the request for urgent transmission and optionally the duration of the request may be included in one or more subfields of the HT control field. In another embodiment, the frame from the STA may be an existing or a new action frame, and the request for urgent transmission and optionally the duration of the request are provided in action elements of the action frame

In another embodiment, as described above, the frame from the STA (e.g., frame 1220 or 1320) may comprise a request for urgent transmission, one or more fields of a QoS Characteristics element, BSR information, and optionally a duration of the request as shown in FIG. 14B. In an embodiment, the frame from the STA may be a QoS null frame similar to QoS null frame 400 described with reference to FIG. 4 above. The QoS null frame may comprise BSR information. The QoS null frame may further comprise an A-Control field comprising the one or more fields of the QoS Characteristics element. The request for urgent transmission and optionally the duration of the request may be included in one or more subfields of the A-Control field. In another embodiment, the duration of the request may be provided in the BSR information fields.

In another embodiment, as described above, the frame from the STA (e.g., frame 1220 or 1320) may comprise a request for urgent transmission, a QoS Characteristics element, BSR information, and optionally a duration of the request as shown in FIG. 14C. In an embodiment, the frame from the STA may be an action frame. The action frame may comprise BSR information. The BSR information may comprise the QoS Characteristics element. The request for urgent transmission and optionally the duration of the request may be included in one or more subfields of the action frame. In another embodiment, the duration of the request may be provided in the BSR information fields.

In another embodiment, as described above, the frame from the STA (e.g., frame 1220 or 1320) may comprise a request for urgent transmission, a QoS Characteristics element, and optionally a duration of the request as shown in FIG. 14D. In an embodiment, the frame from the STA may be an SCS request frame. The SCS request frame may comprise an SCS Descriptor element, where the SCS Descriptor element comprises the QoS Characteristics element. The request for urgent transmission may be included in reserved bits of the Control Info field of the QoS Characteristics element. The duration of the request may be included in the Medium Time field, the Delay Bound field, or another field of the QoS Characteristics element.

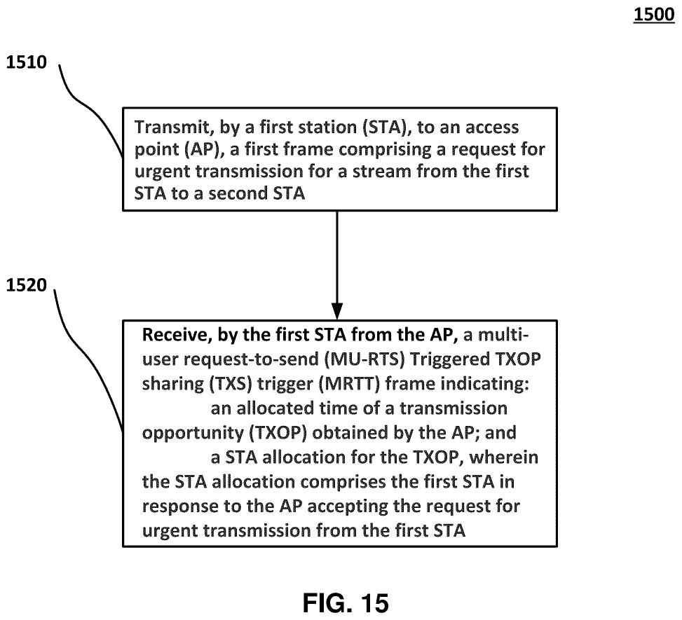

FIG. 15 illustrates an example process 1500 according to an embodiment. Example process 1500 is provided for the purpose of illustration only and is not limiting. Example process 1500 may be performed by a first STA, such as STA 1211, for example, in the context of a TXS procedure.

As shown in FIG. 15, process 1500 may include, in step 1510, transmitting by the first STA, to an AP, a first frame comprising a request for urgent transmission (e.g., a request for a TXOP) for a stream from the first STA to a second STA. In an embodiment, the first STA is associated with the AP. In an embodiment, the request for urgent transmission indicates a request for allocation of the first STA during a TXOP obtained by the AP. In an embodiment, the first frame further comprises a duration, where the duration indicates a required channel access time by the first STA.

In an embodiment, the first frame further comprises QoS parameters associated with the stream. The QoS parameters may be provided in a QoS Characteristics element. In an embodiment, the first frame requests a classification of the stream based on the QoS parameters, where the requested classification is intended to override an existing classification of the stream for an indicated duration. In another embodiment, the first frame requests a classification of the stream based on the QoS parameters, where the requested classification is intended to change an existing classification of the stream.

In an embodiment, the first frame comprises a QoS null frame, where the QoS null frame comprises BSR information. In an embodiment, the QoS null frame further comprises an A-Control field comprising the QoS parameters associated with the stream. In an embodiment, the first frame comprises a data frame. In another embodiment, the first frame comprises a BSR frame.

In another embodiment, the first frame comprises an action frame, where the action frame comprises BSR information. In an embodiment, the BSR information comprises the QoS parameters associated with the stream.

In another embodiment, the first frame comprises an SCS request frame, where the SCS request frame comprises an SCS Descriptor element. In an embodiment, the SCS Descriptor element comprises the QoS parameters associated with the stream.

In step 1520, process 1500 may include receiving by the first STA from the AP, a multi-user request-to-send (MU-RTS) triggered TXOP sharing (TXS) trigger (MRTT) frame. The MRTT frame may indicate an allocated time of a TXOP obtained by the AP. The MRTT frame may also indicate a STA allocation for the TXOP. In an embodiment, the STA allocation may comprise the first STA in response to the AP accepting the request for urgent transmission and/or the QoS parameters from the first STA. In another embodiment, the STA allocation may comprise the first STA when the AP accepts the request for urgent transmission from the first STA and the requested classification of the stream based on the QoS parameters. In another embodiment, the STA allocation may not comprise the first STA when the AP rejects the request for urgent transmission and/or the QoS parameters from the first STA.

In an embodiment, the MRTT frame may comprise an allocation duration for the first STA, the allocation duration configured to allow the first STA to transmit a second frame to the second STA. In an embodiment, process 1500 further includes transmitting a second frame by the first STA to the second STA. The second frame may be associated with urgent data at the first STA. The urgent data may be data that must be transmitted within T-units of time from its arrival at the first STA. In an embodiment, process 1500 further includes transmitting a CTS frame before transmitting the second frame and receiving a BA frame from the second STA in response to the second frame. In an embodiment, the second frame comprises a PPDU frame.

In an embodiment, process 1500 may further comprise (e.g., before step 1510) transmitting, to the AP, a stream classification service (SCS) request for the stream comprising a first QoS Characteristics element. The process 1500 may further comprise receiving, from the AP, an SCS response for the stream comprising a second QoS Characteristics element.

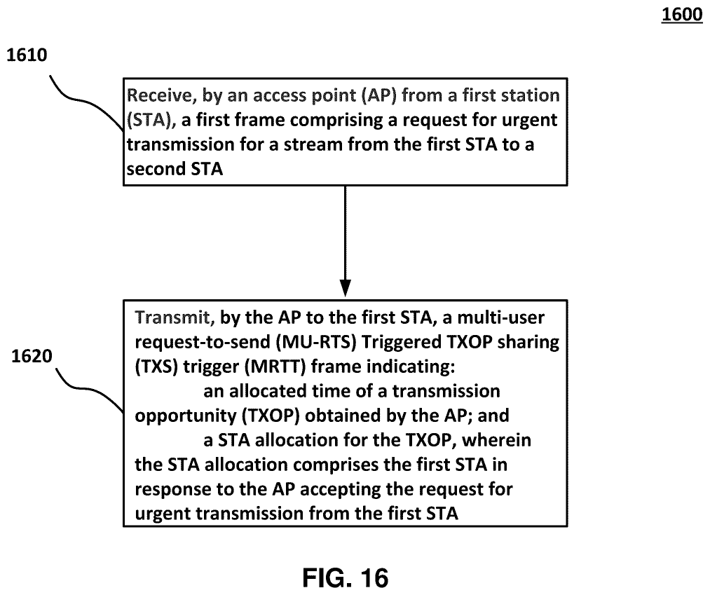

FIG. 16 illustrates another example process 1600 according to an embodiment. Example process 1600 is provided for the purpose of illustration only and is not limiting. Example process 1600 may be performed by an AP, such as AP 1210, for example, in the context of a TXS procedure.

As shown in FIG. 16, process 1600 may include, in step 1610, receiving by the AP, from a first STA, a first frame comprising a request for urgent transmission (e.g., a request for a TXOP) for a stream from the first STA to a second STA. In an embodiment, the first STA is associated with the AP. In an embodiment, the request for urgent transmission indicates a request for allocation of the first STA during a TXOP obtained by the AP. In an embodiment, the first frame further comprises a duration, where the duration indicates a required channel access time by the first STA.

In an embodiment, the first frame further comprises QoS parameters associated with the stream. The QoS parameters may be provided in a QoS Characteristics element. In an embodiment, the first frame requests a classification of the stream based on the QoS parameters, where the requested classification is intended to override an existing classification of the stream for an indicated duration. In another embodiment, the first frame requests a classification of the stream based on the QoS parameters, where the requested classification is intended to change an existing classification of the stream.

In an embodiment, the first frame comprises a QoS null frame, where the QoS null frame comprises BSR information. In an embodiment, the QoS null frame further comprises an A-Control field comprising the QoS parameters associated with the stream. In an embodiment, the first frame comprises a data frame. In another embodiment, the first frame comprises a BSR frame.

In another embodiment, the first frame comprises an action frame, where the action frame comprises BSR information. In an embodiment, the BSR information comprises the QoS parameters associated with the stream.

In another embodiment, the first frame comprises an SCS request frame, where the SCS request frame comprises an SCS Descriptor element. In an embodiment, the SCS Descriptor element comprises the QoS parameters associated with the stream.

In step 1620, process 1600 may include transmitting by the AP to the first STA, a multi-user request-to-send (MU-RTS) triggered TXOP sharing (TXS) trigger (MRTT) frame. The MRTT frame may indicate an allocated time of a TXOP obtained by the AP. The MRTT frame may also indicate a STA allocation for the TXOP. In an embodiment, the STA allocation may comprise the first STA in response to the AP accepting the request for urgent transmission and/or the QoS parameters from the first STA. In another embodiment, the STA allocation may comprise the first STA when the AP accepts the request for urgent transmission from the first STA and the requested classification of the stream based on the QoS parameters. In another embodiment, the STA allocation may not comprise the first STA when the AP rejects the request for urgent transmission and/or the QoS parameters from the first STA.

In an embodiment, the MRTT frame may comprise an allocation duration for the first STA, the allocation duration configured to allow the first STA to transmit a second frame to the second STA.

In an embodiment, process 1600 may further comprise (e.g., before step 1610) receiving, from the first STA, a stream classification service (SCS) request for the stream comprising a first QoS Characteristics element. The process 1600 may further comprise transmitting, to the first STA, an SCS response for the stream comprising a second QoS Characteristics element.

What is claimed is:

1. A first station (STA) comprising:
one or more processors; and
memory storing instructions that, when executed by the one or more processors, cause the first STA to:
transmit to an access point (AP) a first frame comprising a request for urgent transmission for a stream from the first STA to a second STA; and
receive from the AP a multi-user request-to-send (MU-RTS) triggered transmission opportunity (TXOP) sharing (TXS) trigger (MRTT) frame indicating:
an allocated time of a transmission opportunity (TXOP) obtained by the AP; and
a STA allocation for the TXOP, wherein the STA allocation comprises the first STA in response to the AP accepting the request for urgent transmission from the first STA.

2. The first STA of claim 1, wherein the request for urgent transmission indicates a request for allocation of the first STA during the TXOP obtained by the AP.

3. The first STA of claim 1, wherein the first frame further comprises Quality of Service (QOS) parameters associated with the stream, and wherein the QoS parameters are provided in a QoS Characteristics element of the first frame.

4. The first STA of claim 3, wherein the first frame requests a classification of the stream based on the QoS parameters.

5. The first STA of claim 3, wherein the first frame comprises a stream classification service (SCS) request frame, and wherein the SCS request frame comprises an SCS Descriptor element, the SCS Descriptor element comprising the QoS parameters associated with the stream.

6. The first STA of claim 1, wherein the first frame comprises a QoS null frame or an action frame, and wherein the first frame comprises buffer status report (BSR) information.

7. The first STA of claim 1, wherein the STA allocation does not comprise the first STA when the AP rejects the request for urgent transmission from the first STA.

8. The first STA of claim 1, wherein the MRTT frame comprises an allocation duration for the first STA, the allocation duration configured to allow the first STA to transmit a second frame to the second STA.

9. The first STA of claim 1, wherein the first frame further comprises a duration that indicates a required channel access time by the first STA.

10. An access point (AP) comprising:
one or more processors; and
memory storing instructions that, when executed by the one or more processors, cause the AP to:
receive from a first station (STA) a first frame comprising a request for urgent transmission for a stream from the first STA to a second STA; and
transmit to the first STA a multi-user request-to-send (MU-RTS) Triggered Transmission Opportunity (TXOP) Sharing (TXS) trigger (MRTT) frame indicating:
an allocated time of a transmission opportunity (TXOP) obtained by the AP; and
a STA allocation for the TXOP, wherein the STA allocation comprises the first STA in response to the AP accepting the request for urgent transmission from the first STA.

11. The AP of claim 10, wherein the request for urgent transmission indicates a request for allocation of the first STA during the TXOP obtained by the AP.

12. The AP of claim 10, wherein the first frame further comprises Quality of Service (QOS) parameters associated with the stream, and wherein the QoS parameters are provided in a QoS Characteristics element of the first frame.

13. The AP of claim 12, wherein the first frame requests a classification of the stream based on the QoS parameters.

14. The AP of claim 12, wherein the first frame comprises a stream classification service (SCS) request frame, and wherein the SCS request frame comprises an SCS Descriptor element, the SCS Descriptor element comprising the QoS parameters associated with the stream.

15. The AP of claim 10, wherein the first frame comprises a QoS null frame or an action frame, and wherein the first frame comprises buffer status report (BSR) information.

16. The AP of claim 10, wherein the STA allocation does not comprise the first STA when the AP rejects the request for urgent transmission from the first STA.

17. The AP of claim 10, wherein the MRTT frame comprises an allocation duration for the first STA, the allocation duration configured to allow the first STA to transmit a second frame to the second STA.

18. The AP of claim 10, wherein the first frame further comprises a duration that indicates a required channel access time by the first STA.

19. A non-transitory computer-readable medium comprising instructions that, when executed by one or more processors of a station (STA), cause the STA to:
transmit to an access point (AP) a first frame comprising a request for urgent transmission for a stream from the first STA to a second STA; and
receive from the AP a multi-user request-to-send (MU-RTS) triggered transmission opportunity (TXOP) sharing (TXS) trigger (MRTT) frame indicating:
an allocated time of a transmission opportunity (TXOP) obtained by the AP; and
a STA allocation for the TXOP, wherein the STA allocation comprises the first STA in response to the AP accepting the request for urgent transmission from the first STA.

20. The non-transitory computer-readable medium of claim 19, wherein the request for urgent transmission indicates a request for allocation of the first STA during the TXOP obtained by the AP.
